(19) United States
(12) Patent Application Publication
(10) Pub. No.: US 2013/0055230 A1
(43) Pub. Date: Feb. 28, 2013

(54) METHOD AND APPARATUS TO INSTALL SOFTWARE AUTOMATICALLY

(71) Applicant: Jae-hwan KIM, Seoul (KR)

(72) Inventor: Jae-hwan KIM, Seoul (KR)

(73) Assignee: Samsung Electronics Co., Ltd, Suwon-si (KR)

(21) Appl. No.: 13/533,221

(22) Filed: Jun. 26, 2012

(30) Foreign Application Priority Data
Aug. 31, 2011 (KR) 10-2011-0088233

(51) Int. Cl. G06F 9/445

(52) U.S. Cl. 717/168

(57) ABSTRACT

In an apparatus to install software, when a Basic Input/Output System (BIOS) that is stored in a first storage unit is driven, a first program that is stored in the first storage unit is copied to a second storage unit. Thus, when an operating system (OS) is driven, the first program of the second storage unit is executed, and a second program that installs software automatically and updates software is installed so that software may be automatically installed and updated by the second program.

### CROSS-REFERENCE TO RELATED APPLICATIONS

This application claims the benefit of Korean Patent Application No. 10-2011-0088233, filed on Aug. 31, 2011, in the Korean Intellectual Property Office, the disclosure of which is incorporated herein in its entirety by reference.

### BACKGROUND

1. Field

The present general inventive concept relates to an apparatus to install software automatically and to update software.

2. Description of the Related Art

The present general inventive concept relates to a method and apparatus to install software and to update software. Drivers and software that are required to drive hardware devices in a personal computer (PC) may be stored in an additional storage medium, such as a CD-ROM, or may be downloaded by a user from the Internet by using an additional installation utility.

### SUMMARY

The present general inventive concept provides an apparatus and method of installing software automatically and updating software.

Additional features and utilities of the present general inventive concept will be set forth in part in the description which follows and, in part, will be obvious from the description, or may be learned by practice of the general inventive concept.

The present general inventive concept also provides a computer readable recording medium having recorded thereon a program to execute the method.

According to a feature of the present general inventive concept, an apparatus to install software wherein the apparatus includes a first storage unit and a second storage unit, the apparatus including the first storage unit to store a first program that invokes a second program to install software and update software, a Basic Input/Output System (BIOS), a protection unit to protect a first program by performing an operation of copying the first program of the first storage unit to the second storage unit, an installation unit to install the second program by executing the first program of the second storage, and an execution unit to execute the installed second program.

According to another feature of the present general inventive concept, a computer system includes an apparatus to install software that, when a Basic Input/Output System (BIOS) is driven, performs an operation of copying a first program to invoke a second program that is stored in a first storage unit to a second storage unit, installs the second program by executing the first program of the second storage unit and executes the installed second program, and a user interface unit that displays a list of installable software and updates of software according to a result of execution of the second program, wherein the second program is a program that installs and updates software.

According to another feature of the present general inventive concept, a method of installing software includes, when a Basic Input/Output System (BIOS) that is stored in a first storage unit is driven, performing an operation of copying a first program of invoking a second program that is stored in a first storage unit to a second storage unit; installing the second program by executing the first program of the second storage unit; and executing the installed second program, wherein the second program is a program that installs and updates software.

According to another feature of the present general inventive concept, a computer readable recording medium has recorded thereon a program to execute the method.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of a structure of an apparatus to install software according to an exemplary embodiment of the present general inventive concept;

FIG. 2 is a block diagram of a structure of a computer system including the apparatus to install software illustrated in FIG. 1;

FIG. 3 is a flowchart illustrating a method of installing software according to an exemplary embodiment of the present general inventive concept;

FIG. 4 is a flowchart illustrating a method of installing software according to another exemplary embodiment of the present general inventive concept; and

FIG. 5 is a flowchart illustrating an operation of setting whether to copy a first program of a first storage unit to a second storage unit according to a flag by using the apparatus to install software illustrated in FIG. 1, according to an exemplary embodiment of the present general inventive concept.

### DETAILED DESCRIPTION OF THE EXEMPLARY EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

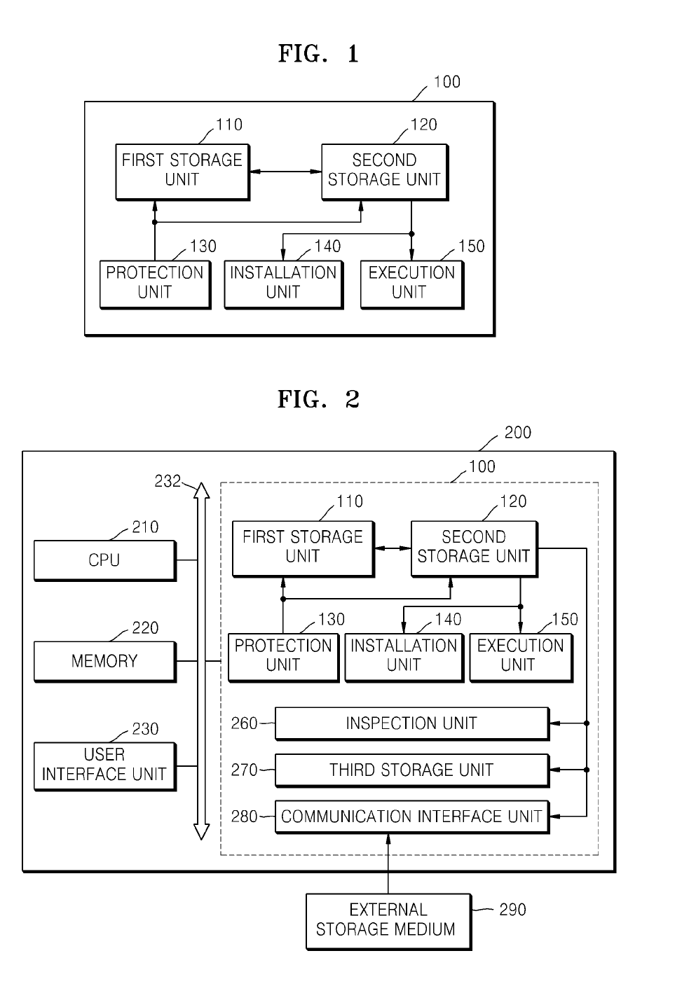

FIG. 1 is a block diagram of a structure of an apparatus 100 to install software according to an exemplary embodiment of the present general inventive concept. Referring to FIG. 1, the apparatus 100 to install software according to at least one exemplary embodiment includes a first storage unit 110, a second storage unit 120, a protection unit 130, an installation unit 140, and an execution unit 150.

The apparatus 100 to install software illustrated in FIG. 1 illustrates elements related to an exemplary embodiment of the present general inventive concept. Thus, it will be understood by one of ordinary skill in the art that general elements other than the elements illustrated in FIG. 1 may be further included in the apparatus 100 to install software of FIG. 1.

The apparatus 100 to install software of FIG. 1 may correspond to and/or include at least one processor. Thus, the apparatus 100 to install software of FIG. 1 may be driven as being included in a general computer system (not shown). Hereinafter, the case wherein the apparatus 100 to install software of FIG. 1 is included in the general computer system will be described below. However, the present general inventive concept is not limited thereto.

The first storage unit 110 stores a first program that invokes a second program to install software and update software and a Basic Input/Output System (BIOS). In this case, when the second program is not installed at the second storage unit 120, the first program may be implemented as a guide program that invokes the second program from inside or outside of the apparatus 100 to install software of FIG. 1 and to install the second program. However, the present general inventive concept is not limited thereto.

Also, the second program, as a program to install software and update software, may be implemented as a software installation and updating program. However, the present general inventive concept is not limited thereto.

The BIOS are codes that are executed first after a computer system operates. The BIOS controls hardware devices of the computer system and drives an operating system (OS). In this case, a procedure of controlling an operation of the computer system by using the BIOS until the operating system (OS) is driven after power is supplied to the computer system, is referred to as a pre-boot mode.

When the BIOS is not executed, the computer system does not operate.

Thus, the BIOS may be stored in the first storage unit 110 as a storage device that cannot delete or modify stored contents readily. Thus, the first storage unit 110 according to the current embodiment may be implemented as a mask read-only memory (ROM), an Erasable and Programmable ROM (EP-ROM), or the like. However, the present general inventive concept is not limited thereto, and various storage mediums including a flash memory, as well as ROM, may be used as the first storage unit 110. Thus, even when a user deletes all programs including the OS, the contents stored in the first storage unit 110 are not deleted from the computer system.

The first storage unit 110 stores the first program together with the BIOS. Since the first program is stored in the first storage unit 110 together with the BIOS, the stored contents cannot be readily deleted or modified. Even when the user deletes all programs by performing formatting or the like of the computer system, the first program that is stored in the first storage unit 110 is not deleted from the computer system.

The first program is a program to invoke the second program. The first program is not executed when it is stored in the first storage unit 110. When the first program is copied by the protection unit 130 and is stored in the second storage unit 120, the OS of the second storage unit 120 is driven so that the first program is automatically executed.

The second storage unit 120 stores a program other than the BIOS, data, or the like. The second storage unit 120 of FIG. 1 may also store the OS. Also, when the OS that is driven by the BIOS of the first storage unit 110 executes other applications that are installed at the computer system, the second storage unit 120 stores data or files to be referred to by the OS. Thus, the second storage unit 120 is implemented as a storage device that can delete the stored contents freely or can modify the stored contents, for example, a hard disk drive (HDD).

When the pre-boot mode that operates by the BIOS is terminated and the OS is driven, the OS controls the overall operation of the computer system. In this case, since the OS controls and executes the applications by referring to data and files stored in the second storage unit 120, the first program of the first storage unit 110 needs to be copied to, and stored in, the second storage unit 120 so that the first program may be executed. Thus, the first program of the first storage unit 110 is copied to the second storage unit 120 by the protection unit 130, and the first program that is stored in the second storage unit 120 is automatically executed when the OS is driven.

The protection unit 130 performs an operation of copying the first program of the first storage unit 110 to the second storage unit 120 when the BIOS is driven. For example, the protection unit 130 may execute a program protection module that is stored in the first storage unit 110 to perform the copying operation of the first program. Thus, the protection unit 130 of FIG. 1 may also be implemented as a program protector, and the present general inventive concept is not limited thereto.

The protection unit 130 operates in the pre-boot mode. That is, when power is supplied to the computer system, the BIOS of the first storage unit 110 is executed, and the first program of the first storage unit 110 is copied to the second storage unit 120 by the protection unit 130 simultaneously when the BIOS of the first storage unit 110 is executed. Also, the apparatus 100 to install software of FIG. 1 may determine whether to activate the operation of the protection unit 130. Detailed description of determining whether to activate the operation of the protection unit 130 will be referred to FIG. 2.

Also, the protection unit 130 determines whether the OS executes the first program automatically when the pre-boot mode is terminated and the OS is driven. Even after all programs in the computer system including the OS are deleted, the first program that is stored in the first storage unit 110 is stored in the second storage unit 120 by the protection unit 130 and the first program that is stored in the second storage unit 120 is executed. Thus, even when the OS is re-installed, the first program of the first storage unit 110 is copied to the second storage unit 120 by the protection unit 130, so that software may be automatically installed and updated, as illustrated in FIG. 1.

The installation unit 140 installs the second program by executing the first program of the second storage unit 120. The installation unit 140 operates by the OS after the pre-boot mode is terminated. The installation unit 140 executes the first program of the second storage unit 120 automatically.

In this case, the executed first program is installed by invoking the second program from the outside or inside of the apparatus 100 to install software of FIG. 1. Invoking of a program refers to loading of the program that has been already installed to execute the program or downloading of files required to install a corresponding program from the inside or outside of the apparatus 100 to install software. The installation unit 140 may be installed by invoking the second program from an additional memory region in the second storage unit 120 or a third storage unit that is separate from the first and second storage units 110 and 120 or another computer system. Detailed description thereof will be referred to FIG. 2.

The execution unit 150 executes the second program that has been installed by the installation unit 140. In this case, the execution unit 150 is controlled by the OS, and the installed second program may be automatically executed by the execution unit 150. When the second program is automatically executed, a list of installable software and updates of software are displayed to the user, and software that is selected by the user is installed and updated. Software that is installed using the second program may be drivers and applications that are required to drive the hardware devices.

According to the apparatus 100 to install software of FIG. 1, even when all programs including the OS are deleted from the computer system, the user may install software automatically and may update software without any difficulty by invoking the second program to install software automatically and updating software. This is due to the fact that the first program of the first storage unit 110 in which the BIOS is stored is not deleted even when other programs are deleted from the computer system.

FIG. 2 is a block diagram of a structure of a computer system 200 including the apparatus 100 to install software illustrated in FIG. 1. Referring to FIG. 2, the computer system 200 includes the apparatus 100 to install software, a central processing unit (CPU) 210, a memory 220, and a user interface unit 230. A bus 232 may be included to allow communication between the CPU 210, memory 220, user interface unit 230 and the computer system 200.

The computer system 200 refers to a computing system that functions as a general computer, for example, execution of programs and control of the system. Examples of the computer system 200 include personal computers (PC), such as desktop computers, lap top computers, and the like. The apparatus 100 to install software operates in the computer system 200.

In at least one embodiment, the apparatus 100 to install software illustrated in FIG. 2 includes a first storage unit 110, a second storage unit 120, a protection unit 130, an installation unit 140, an execution unit 150, an inspection unit 260, a third storage unit 270, and a communication interface unit 280. The first storage unit 110, the second storage unit 120, the protection unit 130, the installation unit 140, and the execution unit 150 illustrated in FIG. 2 are the same as the first storage unit 110, the second storage unit 120, the protection unit 130, the installation unit 140, and the execution unit 150 of the apparatus 100 to install software of FIG. 1, and repeated description thereof will not be provided here. The apparatus 100 to install software is not limited to the elements illustrated in FIG. 2.

The first storage unit 110 stores the BIOS, as described in FIG. 1 and corresponds to a BIOS ROM in the computer system 200. The first storage unit 110 may further store a flag that indicates the operating state of the second program as well as the first program.

The first storage unit 110 stores the flag that indicates the operating state of the second program when the operating system (OS) of the computer system 200 is terminated, restarts, or enters into a maximum power-saving mode or hibernation.

Thus, when the apparatus 100 to install software is re-driven and is in the pre-boot mode, the apparatus 100 to install software refers to the flag that is stored in the first storage unit 110 by using the protection unit 130. That is, the apparatus 100 to install software may determine whether to copy the first program of the first storage unit 110 to the second storage unit 120 according to the operating state of the second program by referring to the flag that is stored in the first storage unit 110.

The second storage unit 120 stores the OS that is driven by the BIOS and corresponds to a hard disk drive (HDD). It will be understood by one of ordinary skill in the art that the second storage unit 120 may be another storage medium to store the OS as well as the hard disk drive (HDD).

The protection unit 130 determines whether to copy the first program to the second storage unit 120 by referring to a flag that is stored in the first storage unit 110. That is, the protection unit 130 determines whether to copy the first program to the second storage unit 120 according to the operating state of the second program.

When the second program has already operated before the apparatus 100 to install software is re-driven and is in the pre-boot mode, a flag indicating that the second program is operating is set so that the protection unit 130 determines that there is no need to copy the first program.

Contrary to this, when the second program does not operate, a flag indicating that the second program is not operating is set so that the protection unit 130 copies the first program of the first storage unit 110 to the second storage unit 120.

In addition, the operation of the protection unit 130 may be activated or deactivated due to user's setting regardless of the operating state of the second program. The user may input information regarding setting whether to activate the protection unit 130 by using the user interface unit 230.

When the protection unit 130 is set in a deactivated state, the protection unit 130 does not perform an operation of copying the first program of the first storage unit 110 to the second storage unit 120. Thus, since the first program is not stored in the second storage unit 120, even when the OS is driven, the first program is not executed. Similarly, since the first program to install or executing the second program is not executed, the second program is also not installed or executed.

The protection unit 130 determines whether to copy the first program of the first storage unit 110 to the second storage unit 120 and to execute the first program. That is, the protection unit 130 determines whether to install and execute the second program to install software automatically and updating software. Thus, the user that does not want to install software automatically and to update software deactivates the operation of the protection unit 130, as described above, so that the second program may be prevented from being automatically executed.

The inspection unit 260 executes the first program of the second storage unit 120 and inspects whether the second program has been installed at the second storage unit 120. When the second program has been already installed at the second storage unit 120, the first program has only to invoke and execute the installed second program without the need of re-installing the second program. Thus, it is determined whether to install the second program of the installation unit 140 according to the result of inspection of the inspection unit 260.

The inspection unit 260 operates by the OS after the pre-boot mode is terminated and automatically executes and inspects the first program of the second storage unit 120. As the result of inspection of the inspection unit 260, when the second program has been installed at the second stooge unit 120, an operation of installing the second program by using the installation unit 140 is not performed, and the execution unit 150 directly performs an operation of executing the second program.

The installation unit 140 is executed when it is inspected by the inspection unit 260 and it is determined that the second program has not been installed at the second storage unit 120. The installation unit 140 installs the second program by obtaining the second program from the outside or inside of the apparatus 100 to install software when the second program has not been installed at the second storage unit 120.

In this case, the inside of the apparatus 100 to install software may be a memory region in the second storage unit 120 or the third storage unit 270 that is separate from the second storage unit 120.

In addition, obtaining of the second program from the outside of the apparatus 100 to install software refers to receiving the second program from an external storage medium 290 on a network by using the communication interface unit 280. For example, the external storage medium 290 on the network may include another computer system that is disposed at a remote place of the computer system 200, a server device, and the like.

The execution unit 150 executes the second program that has been installed at the apparatus 100 to install software according to the result of inspection of the inspection unit 260. In this regard, the second program that has been installed at the apparatus 100 to install software includes the already-installed second program and/or the second program that is installed by the installation unit 140.

When the second program is executed, as described with reference to FIG. 1, the user interface unit 230 displays a list of installable software and updates of software to the user, and the user may select software to be installed or updated by using the user interface unit 230.

The third storage unit 270 stores the second program. It will be understood by one of ordinary skill in the art that the third storage unit 270 may be implemented as the HDD, a flash memory, a memory card or the like.

In FIG. 2, the third storage unit 270 is included in the apparatus 100 to install software for convenience of explanation. However, the present general inventive concept is not limited thereto, and the third storage unit 270 may be included in the memory 220 in the computer system 200. Thus, the installation unit 140 installs the second program by obtaining the second program from the third storage unit 270 of the apparatus 100 to install software or the computer system 200.

The communication interface unit 280 receives the second program from another computer system or a server device on the network that is connected to the apparatus 100 to install software. In FIG. 2, the communication interface unit 280 is included in the apparatus 100 to install software. However, the present general inventive concept is not limited thereto. The communication interface unit 280 may be disposed outside the apparatus 100 to install software as an element of the computer system 200. When the second program is not in the computer system 200 including the apparatus 100 to install software, the apparatus 100 to install software obtains the second program from the outside of the computer system 200 by using the communication interface unit 280.

The CPU 210 is a control device that performs an arithmetic operation or data processing and controls the overall operation of the computer system 200 including the apparatus 100 to install software.

The memory 220 stores data and/or a program required to drive the computer system 200. The memory 220 of FIG. 2 may include a main memory unit and a secondary memory unit, and the secondary memory unit may include CD-ROM or the like.

The user interface unit 230 obtains an input signal from the user and displays output information to the user. For example, the user interface unit 230 may include a display panel, a monitor, an input/output device, such as a keyboard, a mouse or the like, which are included with the computer system 200, and a software module to drive them.

The user may input information regarding setting whether to activate the protection unit 130 by using the user interface unit 230. In addition, the execution unit 150 may display a list of installable software and updates of software by using the user interface unit 230, and the user may input information regarding selection of software to be installed from the list by using the user interface unit 230.

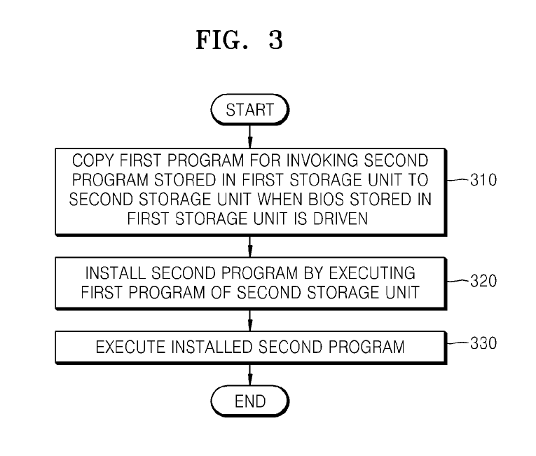

FIG. 3 is a flowchart illustrating a method of installing software according to an exemplary embodiment of the present general inventive concept. Referring to FIG. 3, an exemplary method of installing software includes operations to be performed in a sequential order by using the apparatus 100 to install software illustrated in FIG. 1. Thus, although omitted, description of the apparatus 100 to install software of FIG. 1 as described above may be applied to the method of installing software.

In operation 310, the apparatus 100 to install software copies the first program to invoke the second program that is stored in the first storage unit 110 to the second storage unit 120 when the BIOS that is stored in the first storage unit 110 is driven. That is, the apparatus 100 to install software copies the first program of the first storage unit 110 and stores the first program in the second storage unit 120. Also, when the pre-boot mode is terminated and the OS is driven, the apparatus 100 to install software may set the first program that is copied to the second storage unit 120 to be automatically executed.

In operation 320, the apparatus 100 to install software installs the second program by executing the first program of the second storage unit 120. In this case, the apparatus 100 to install software may invoke the second program from the inside or outside of the apparatus 100 to install software. In this case, after the second program has been installed, the apparatus 100 to install software may modify setting of the OS or may delete the first program from the computer system so that the first program that is stored in the second storage unit 120 may not be automatically executed any more.

In operation 330, the apparatus 100 to install software executes the installed second program. The apparatus 100 to install software displays a list of installable software and updates of software by using the second program. Thus, the user may use a program to install software automatically and update software easily even when the OS is re-installed.

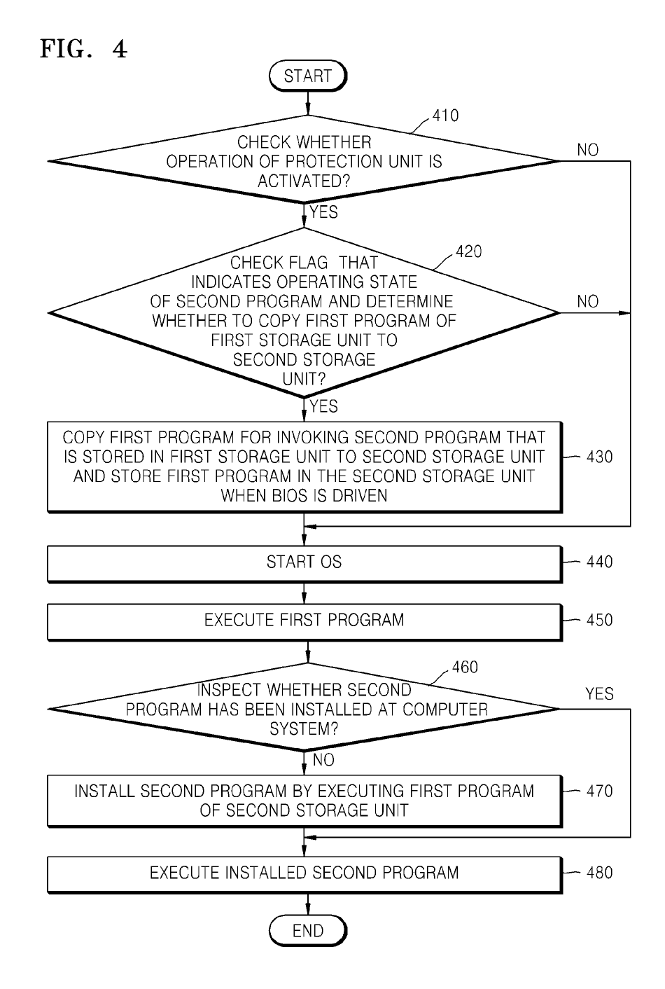

FIG. 4 is a flowchart illustrating a method of installing software according to another exemplary embodiment of the present general inventive concept. Referring to FIG. 4, the method of installing software may include operations to be performed in a sequential order by using the computer system 200 illustrated in FIG. 2. Thus, although omitted, description of the computer system 200 of FIG. 2 as described above may be applied to the method of installing software.

In operation 410, the apparatus 100 to install software checks whether the operation of the protection unit 130 is activated. Since the user may set the operation of the protection unit 130 to be activated or deactivated, the apparatus 100 to install software checks whether the operation of the protection unit 130 is activated. When the operation of the protection unit 130 is activated, the apparatus 100 to install software proceeds operation 420, and when the operation of the protection unit 130 is deactivated, the apparatus 100 to install software proceeds operation 440.

In operation 420, when it is checked in operation 410 that the protection unit 130 is activated, the apparatus 100 to install software checks a flag that indicates the operating state of the second program and determines whether to copy the first program of the first storage unit 110 to the second storage unit 120. That is, the apparatus 100 to install software checks the flag that is stored in the first storage unit 110, determines whether the second program in the computer system 200 operates and determines whether to copy the first program according to the result of determination. When it is determined that the first program is to be copied, the apparatus 100 to install software proceeds with operation 430, and when it is determined that the first program is not to be copied, the apparatus 100 to install software proceeds with operation 440.

In operation 430, when the BIOS is driven, the apparatus 100 to install software copies the first program to invoke the second program that is stored in the first storage unit 110 to the second storage unit 120 and stores the first program in the second storage unit 120.

In operation 440, the pre-boot mode is terminated, and the OS is driven. In

In operation 430, the apparatus 100 to install software may set the first program that is copied to the second storage unit 120 to be automatically executed when the OS is driven.

In operation 450, the apparatus 100 to install software executes the first program of the second storage unit 120. When the pre-boot mode is terminated and the OS is driven, the first program of the second storage unit 120 is executed.

In operation 460, the apparatus 100 to install software inspects whether the second program has been installed at the computer system 200 or not. When it is inspected and determined that the second program has not been installed at the computer system 200, the apparatus 100 to install software proceeds with operation 470, and when it is inspected and determined that the second program has been installed at the computer system 200, the apparatus 100 to install software proceeds with operation 480 directly without performing operation 470.

In operation 470, the apparatus 100 to install software installs the second program by executing the first program of the second storage unit. The apparatus 100 to install software executes the second program. When it is inspected and determined in operation 460 that the second program has not been installed at the computer system 200, the apparatus 100 to install software installs the second program by invoking the second program from the inside or outside of the computer system 200.

In operation 480, the apparatus 100 to install software executes the installed second program. In this case, the apparatus 100 to install software may perform installation and updating of software automatically by executing the second program, or may allow the user to select software to be installed by displaying a list of installable software and updates of software.

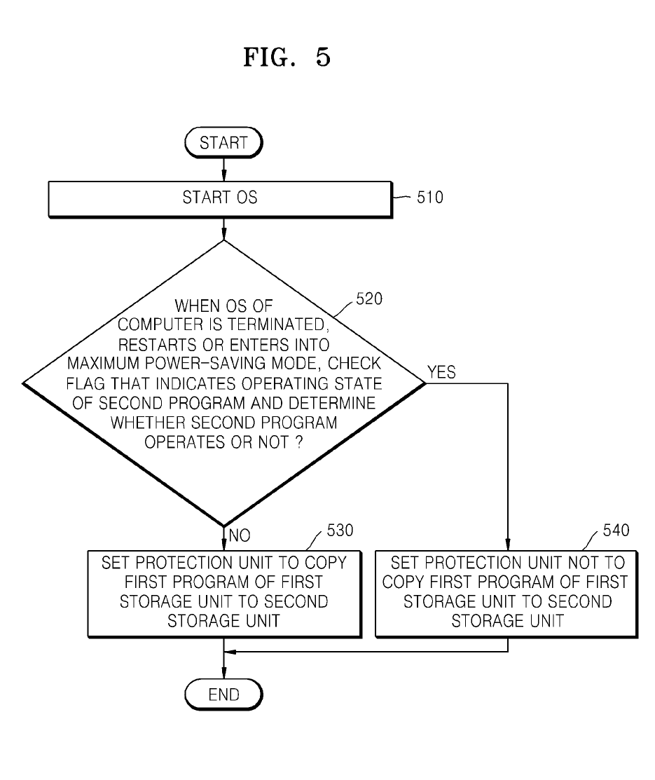

FIG. 5 is a flowchart illustrating an operation of setting whether to copy a first program of the first storage unit 110 to the second storage unit 120 according to a flag by using the apparatus 100 to install software illustrated in FIG. 1, according to an exemplary embodiment of the present general inventive concept. In FIG. 5, the operation of setting whether to copy the first program is performed referring to the flag that is stored in the first storage unit 110 during the time from after starting of the OS to before termination of the OS. In operation 510, the pre-boot mode is terminated, and the OS is driven.

When the second program is running, the apparatus 100 to install software sets the flag that indicates the operating state of the second program in the first storage unit 110.

In operation 520, when the OS of the computer system 200 is terminated, restarts or enters into a maximum power-saving mode, the apparatus 100 to install software checks the flag that indicates an operating state of the second program and determines whether the second program operates. When, as a result of referring to the flag, it is determined that the second program does not operate, the apparatus 100 to install software proceeds with operation 530, and when it is determined that the second program is operating, the apparatus 100 to install software proceeds with operation 540.

In operation 530, since, as a result of a determination in operation 520, when the second program does not operate, the apparatus 100 to install software sets the protection unit 130 to copy the first program of the first storage unit 110 to the second storage unit 120 to execute the second program.

In operation 540, since, as a result of determination in operation 520, when the second program is operating, the apparatus 100 to install software sets the protection unit 130 not to copy the first program of the first storage unit 110 to the second storage unit 120. Thus, the apparatus 100 to install software sets the protection unit 130 not to copy the first program of the first storage unit 110 to the second storage unit 120.

When the OS is terminated and power is re-supplied to the apparatus 100 to install software, the protection unit 130 that is driven when the BIOS operates, operates according to the setting in operation 530 or 540. That is, the protection unit 130 of the apparatus 100 to install software copies the first program of the first storage unit 110 to the second storage unit 120 when it is set to copy the first program of the first storage unit 110 to the second storage unit 120.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.>>

As discussed with respect to the exemplary embodiment described above, even after all programs in a computer system including an operating system (OS) are deleted, a first program that is stored in a first storage unit in which a BIOS is stored, may be prevented from being deleted. Thus, a user may install software automatically and may update software without any difficulty by invoking a second program to install software automatically and updating software.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to install software and comprising a first storage unit and a second storage unit, the apparatus comprising:
the first storage unit to store a first program that invokes a second program to install software and update software, and a Basic Input/Output System (BIOS);
a protection unit to protect the first program by performing an operation of copying the first program of the first storage unit to the second storage unit;
an installation unit to install the second program by executing the first program of the second storage; and
an execution unit to execute the installed second program.

2. The apparatus of claim 1, further comprising an inspection unit to inspect whether the second program has been installed by executing the first program of the second storage program, wherein, when the second program has not been installed, as a result of inspection, the installation unit installs the second program by invoking the second program from at least one of an outside and an inside of the apparatus.

3. The apparatus of claim 1, further comprising a third storage unit to store the second program, wherein the installation unit installs the second program that is stored in the third storage unit.

4. The apparatus of claim 1, further comprising a communication interface unit to receive the second program from an external storage device, wherein the installation unit installs the received second program.

5. The apparatus of claim 1, wherein the first storage unit stores a flag that indicates an operating state of the second program, and when it is determined that the second program does not operate based on the flag, the protection unit copies the first program to the second storage unit and stores the first program in the second storage unit.

6. The apparatus of claim 5, wherein, when an operating system (OS) of the apparatus is terminated or enters into a maximum power-saving mode, the first storage unit stores the flag that indicates the operating state of the second program.

7. The apparatus of claim 1, wherein the execution unit executes the second program and displays a list of installable software and updates of software.

8. The apparatus of claim 1, further comprising a determination unit to determine whether to activate the protection unit according to information set by a user.

9. A computer system comprising:
an apparatus to install software that, when a Basic Input/Output System (BIOS) is driven, performs an operation of copying a first program to invoke a second program that is stored in a first storage unit to a second storage unit, installs the second program by executing the first program of the second storage unit and executes the installed second program; and
a user interface unit that displays a list of installable software and updates of software according to a result of execution of the second program,
wherein the second program is a program that installs and updates software.

10. The computer system of claim 9, wherein the apparatus to install software inspects whether the second program has been installed by executing the first program of the second storage unit, and when the second program has not been installed, as a result of inspection, the apparatus installs the second program by invoking the second program from at least one of an outside and an inside of the apparatus to install software.

11. The computer system of claim 9, further comprising a third storage unit to store the second program, wherein the apparatus to install software installs the second program that is stored in the third storage unit.

12. The computer system of claim 9, further comprising a communication interface unit to receive the second program from an external storage device, wherein the apparatus to install software installs the received second program.

13. The computer system of claim 9, wherein the first storage unit stores a flag that indicates an operating state of the second program, and when it is determined that the second program does not operate based on the flag, the apparatus to install software copies the first program to the second storage unit and stores the first program in the second storage unit.

14. A method of installing software, the method comprising:
when a Basic Input/Output System (BIOS) that is stored in a first storage unit is driven, performing an operation of copying a first program to invoke a second program that is stored in a first storage unit to a second storage unit;
installing the second program by executing the first program of the second storage unit; and
executing the installed second program,
wherein the second program is a program that installs and updates software.

15. The method of claim 14, further comprising inspecting whether the second program has been installed by executing the first program of the second storage unit, wherein, when the second program has not been installed, as a result of inspection, the installing of the second program comprises installing the second program by invoking the second program from at least one of an outside and an inside of the apparatus to install software.

16. The method of claim 14, wherein the installing of the second program comprises installing the second program that is stored in a third storage unit.

17. The method of claim 14, further comprising receiving the second program from an external storage device, wherein the installing of the second program comprises installing the received second program.

18. The method of claim 14, wherein the performing of the operation of copying the first program comprises, when it is determined that the second program does not operate based on a flag that indicates an operating state of the second program that is stored in the first storage unit, copying the first program to the second storage unit and storing the first program in the second storage unit.

19. The method of claim 14, further comprising displaying a list of installable software and updates of software by executing the second program.

20. A non-transitory computer readable recording medium having recorded thereon a program to execute the method of claim 14.
